(19) United States
(12) Patent Application Publication
(10) Pub. No.: US 2010/0280828 A1
(43) Pub. Date: Nov. 4, 2010

(54) Communication Device Language Filter

(76) Inventors: Gene Fein, Malubu, CA (US); Edward Merritt, Lenox, MA (US)

Correspondence Address: Whitaker Law Group, 1218 Third Avenue, Suite 1809, Seattle, WA, 98101, US

(21) Appl. No.: 12/432,969

(22) Filed: Apr. 30, 2009

(51) Int. Cl. G10L 17/00; G10L 15/04

(52) U.S. Cl. 704/246; 704/251; 704/E17.001; 704/E15.005

(57) ABSTRACT

Techniques are described that generally relate to systems, methods, and devices designed to selectively filter offensive communications in accordance with a user's intentions. Example methods may be designed to filter (such as by deleting, blocking, replacing, and/or modifying) various offensive words, phrases, and/or sounds that have been identified as having offensive meanings.

### BACKGROUND INFORMATION

The rapid miniaturization and increased efficiency of electronics and related components has led to the proliferation of telephonic communication devices such as cell phones. For example, a larger range of diverse people now carry around and use cell phones to communicate with each other. Thus, a greater opportunity exists for telephonic communications between diverse people.

### BRIEF DESCRIPTION OF THE DRAWINGS

This disclosure describes only certain embodiments, the features of which will become apparent from the following description, in conjunction with the accompanying drawings, and the appended claims. The drawings depict only certain embodiments and are, therefore, not to be considered limiting of the scope of the claims. The disclosure will be described with additional specificity and detail through use of the accompanying drawings.

In the drawings:

FIG. 1 is a functional block diagram of a distributed system for language filtering in communication devices;

FIG. 2 is an operational block diagram of a server-based system for language filtering in communication devices;

FIG. 3 is a functional block diagram of a server-based system for language filtering in communication devices;

FIG. 4 is a functional block diagram of a peer-to-peer based system for language filtering in communication devices;

FIG. 5 is an operational flow diagram generally illustrating a process for filtering offensive language;

FIG. 6 is a diagram generally illustrating a computer product configured to provide language filtering as shown in FIG. 1; and

FIG. 7 is a block diagram illustrating an example computing device that is arranged for language filtering, in accordance with the present disclosure, all arranged in accordance with at least some embodiments of the present disclosure.

### DETAILED DESCRIPTION OF ILLUSTRATIVE EMBODIMENTS

In the following detailed description, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be used, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, computer programs and systems related to communication systems. Certain embodiments of one such system are illustrated in the figures and described below. Many other embodiments are also possible, however, time and space limitations prevent including an exhaustive list of those embodiments in one document. Accordingly, other embodiments within the scope of the claims will become apparent to those skilled in the art from the teachings of this disclosure.

A system is generally described that provides language filtering, such as may be used in conjunction with a telephonic device. Briefly described, some embodiments illustrate filtering capabilities based on pattern recognition technology (such as voice recognition technology) for selectively filtering communications in accordance with a user's intentions. In various embodiments, a central server or distributed processors may be used to filter (such as by deleting, replacing, and/or modifying) various offensive words, phrases, and/or sounds that have offensive meanings. For example, the language filtering system may identify to-be-filtered words by accessing a database to determine rules that are associated with the to-be-filtered words. The rules may be specified by users of the language filtering system.

Voice communications between (and/or amongst) people who speak over telephonic devices (including cellphones and other wireless devices) may sometimes include offensive language such as profanity or offensive sounds. Thus, children, for example, may be exposed to such language, either voluntarily or unwittingly, based on the situation at hand. It may be difficult to block selected content in “live” communications because (for example) a listener often may not have advance warning that offensive language is about to occur. Even when the offensive communications are blocked (such as by muting the speaker), it may be difficult to know when to continue on with the conversation without increasing the possibility of hearing even more offensive language.

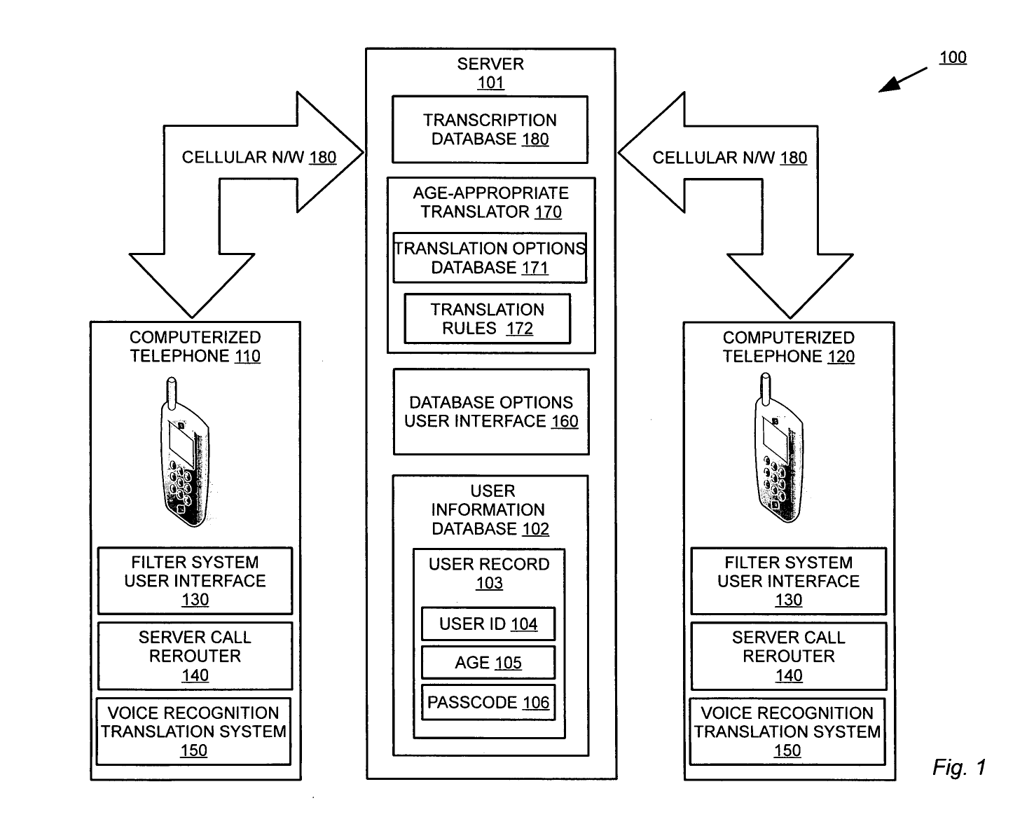

FIG. 1 is a functional block diagram of a distributed system 100 for language filtering in communication devices, in accordance with the present disclosure. The system 100 may be arranged to allow deleting, replacing, and/or modifying of offensive language based upon system settings and controls. For example, certain language that the user or guardian may specify (and/or select) as inappropriate in live conversations may be filtered by use of voice recognition and rules-based content filtering as discussed below.

System 100 may include one or more of a server 101, a computerized telephone 110, or a computerized telephone 120. Server 101 and any of numerous computerized telephones (such as computerized telephones 110 and 120) may be coupled together using any suitable network (such as cellular network 180). Server 101 may comprise a user information database 102 arranged for storing information about users using one or more user records 103. For example, user record 103 may include fields for a user ID 104, an age 105, and a passcode 106. Server 101 may include database options user interface 160 for selecting language filter options for each user. Database options user interface 160 may include multilingual support.

Server 101 may also include age-appropriate translator 170, which may further include a translation options database 171 that may be used to translate offensive language in live conversations. The age-appropriate translator 170 may translate offensive language using an age-based selection criterion. Age-appropriate translator 170 may be arranged to translate offensive language in a conversation in accordance with the identified age of the participant in the conversation using one or more translation rules 172.

It should be noted that, although age is used as one example criterion for filtering language, many other personal criteria could also form the basis for filtering language. For example, personal criteria other than age include, but are not limited to, a lifestyle choice, a religion, a sexual orientation, an ethical position, and/or a moral position. These and many other personal criteria could form the basis of the language filtering performed by the embodiments described herein, and age is described as one example merely for simplicity of discussion and not as a limitation.

Server 101 may also include a transcription database 180 for storing and/or retrieving conversations (for example) between computerized telephone 110 and the computerized telephone 120. More than two phones may be used for language filtering in a conversation, such as may be required in 3-way calling, and in dial-in telephone conference calls. Transcription database 180 may be arranged to store the conversations (for example) during the course of filtering the conversations between (and/or among) two or more participants of the conversation.

In the illustrated embodiment, computerized telephone 110 and computerized telephone 120 each may comprise one or more of a filter system user interface 130, a server call re-router 140, or a voice recognition translation system 150. System user interface 130 may include (for example) a screen and keyboard arranged to provide information and arranged to receive user commands to select, activate, and/or individualize language filter options. Server call re-router 140 may be arranged to re-direct all or portions of language in a communication session between two users to server 101 to determine whether to filter the portions of language. Voice recognition translation system 150 may be arranged to translate individual portions (such as words, phrases, and/or sounds) of a conversation if language in the conversation is offensive. Voice recognition translation system 150 may also be arranged as a user interface to set (or select) options for language filtering by translating commands spoken by a user.

Voice recognition translation system 150 may be arranged to filter offensive language (including words, phrases and/or sounds) from a conversation. Voice recognition translation system 150 may employ a relatively slight delay (around 1 sec.-1.5 sec.) as the voice recognition software processes the data. Voice recognition software 150 may (in some examples) trigger an audible sound effect when deleting identified offensive content.

The filtering of individual users can be changed seamlessly in the middle of a conversation by examining and comparing voice signatures of users that are associated with a phone number (such as members of a “family plan” offered by a cellular network provider). For example, filtering of individual users may be changed in the middle of a conversation from a filter level for a child to a filter level for a parent (such as when a child hands the telephone being used to the parent).

Translations options database 171 may include a database of offensive language that have been selected to be filtered (e.g., blocked) from the user. A guardian, user, or system administrator may access server 101 using a mobile device or a general purpose computer over a network to change default or user settings, for example. The user may specify which offensive language to filter by adding swear words and slurs, as well as words or sounds that may be offensive to the particular user. There may also be a default set of words that includes known offensive language such as words, phrases, and/or sounds. Content deemed to be offensive language may also be specified by using a standard rating, such as “PG-13,” for example. The standard rating may be used by the age-appropriate translator 170 to appropriately filter language in accordance with a user's age. Thus, default settings, user settings, and/or combinations thereof may be used to filter offensive language.

Users may decide to add to-be-filtered language to translations rules 172. For example, while the word ’bitch’ may not be a swear word on its own, the user may find the word to be offensive in some contexts and may decide to add the word to the list of language that is blocked. This may be done using filter system user interface 130 (which may be either voice-and/or GUI-based). The filter system user interface 130 may be arranged to select the custom blocking function by speaking and/or typing the word to be filtered into the system. The translation rules 172 may be saved for later use. The translation rules 172 may also be locked by parents and/or guardians so that their children cannot edit the information.

Context dependent filtering may be performed by the age-appropriate translator 170 that may use translation rules 172. For example, the word “bitch” may be allowable when talking about dogs, while not being allowable in other contexts. Age-appropriate translator 170 may be arranged to translate spoken words and identify the spoken context using translation rules 172 to determine whether the context is such that ambiguously offensive words may be (or may not be) allowed. However, users may override such context filtering by editing translation options database 171 such that ambiguously offensive words are to be always filtered out. Users may utilize the database options user interface 160 to select the option to exclude such words, even when the ambiguously offensive words are used in an appropriate context.

In some examples, filtering of a live conversation may involve one or more of deleting, replacing, and/or modifying offensive language in the live conversation. The replacement and/or modification words may be generated using voice recognition translation system 150. Voice recognition translation system 150 may be arranged to modify offensive spoken language in the live conversation. The spoken language may be modified, for example, by “bleeping” the offensive spoken language with recordings made of the replacement words (such as illustrated in translation rules 272, discussed below). The spoken language may be also modified, for example, by using voice synthesis to generate words that are arranged to replace the offensive spoken language. (The replacement and/or modification words may also be generated on the server 101 using age-appropriate translator 170.)

The kind of filtering to be performed can be specified by a participant by utilizing the database options user interface 160 to specify translation rules 172. For example, translation rules 172 may be arranged to provide the translation rules such as “‘bitch’ near “‘dog’” so that the age-appropriate translator 170 allows the word “bitch” to be spoken within the context of a conversation about “dogs.” The translation rules 172 may be arranged, for example, to replace the word “bitch” with the word “dog” being spoken in a conversation within the context of a conversation about dogs. The translation rules 172 may be arranged to provide the modification word of “animal,” which has an ontologically broader meaning than “bitch” or “dog.” If, for example, “bitch” is spoken in another context, silence (or a triggered sound effect) may be substituted for the word “bitch” so that the ambiguously offensive word may be blocked from the conversation via server 101.

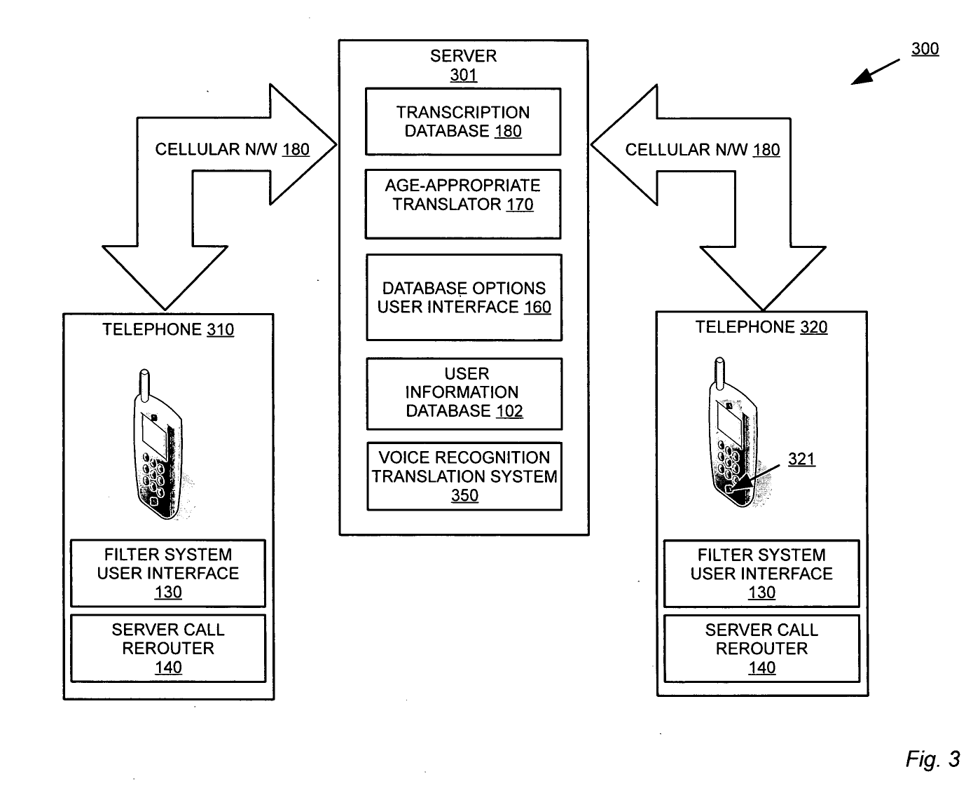

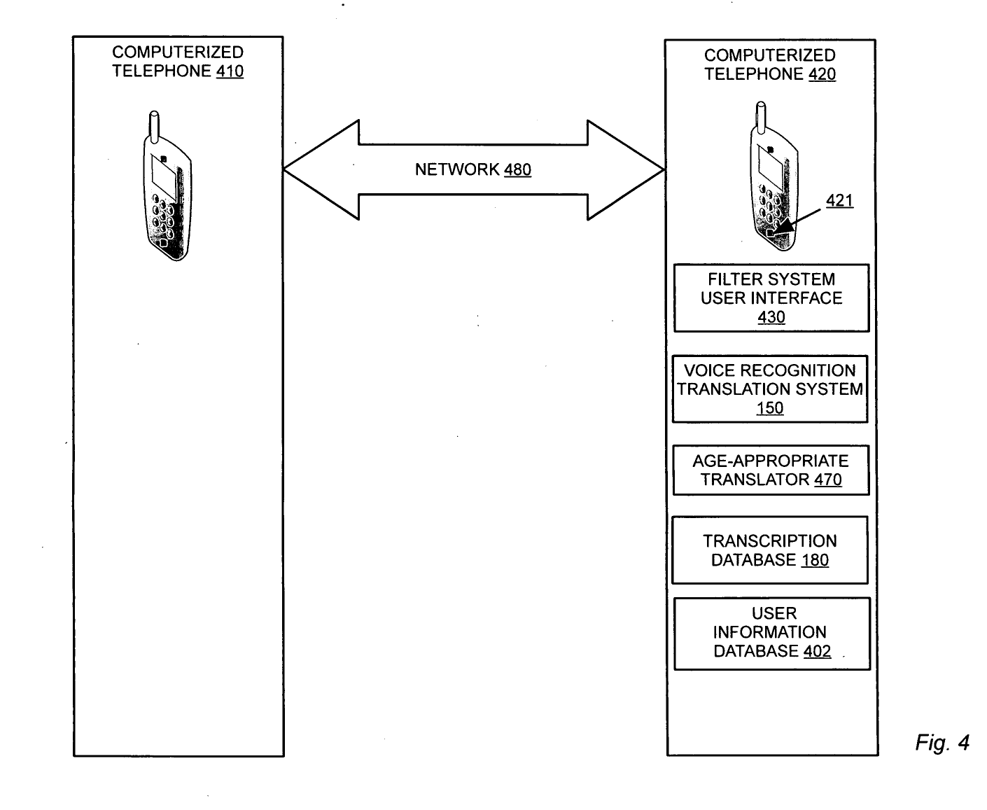

In many embodiments, the components, functions and/or operations of system 100 can be (re)distributed amongst the various devices (such as described below with respect to FIGS. 3 and 4). The distribution of the components may be selected so as to optimize requirements for storage ability, processing power, power dissipation, and system latency in accordance with various device capabilities. Voice recognition translation system 150 may be implemented in either or both of computerized telephone 110 and/or computerized telephone 120. In many embodiments, voice recognition translation system 150 may be implemented in server 101, which (for example) may reduce the potential storage requirements and power consumption requirements for computerized telephones 110 and/or 120.

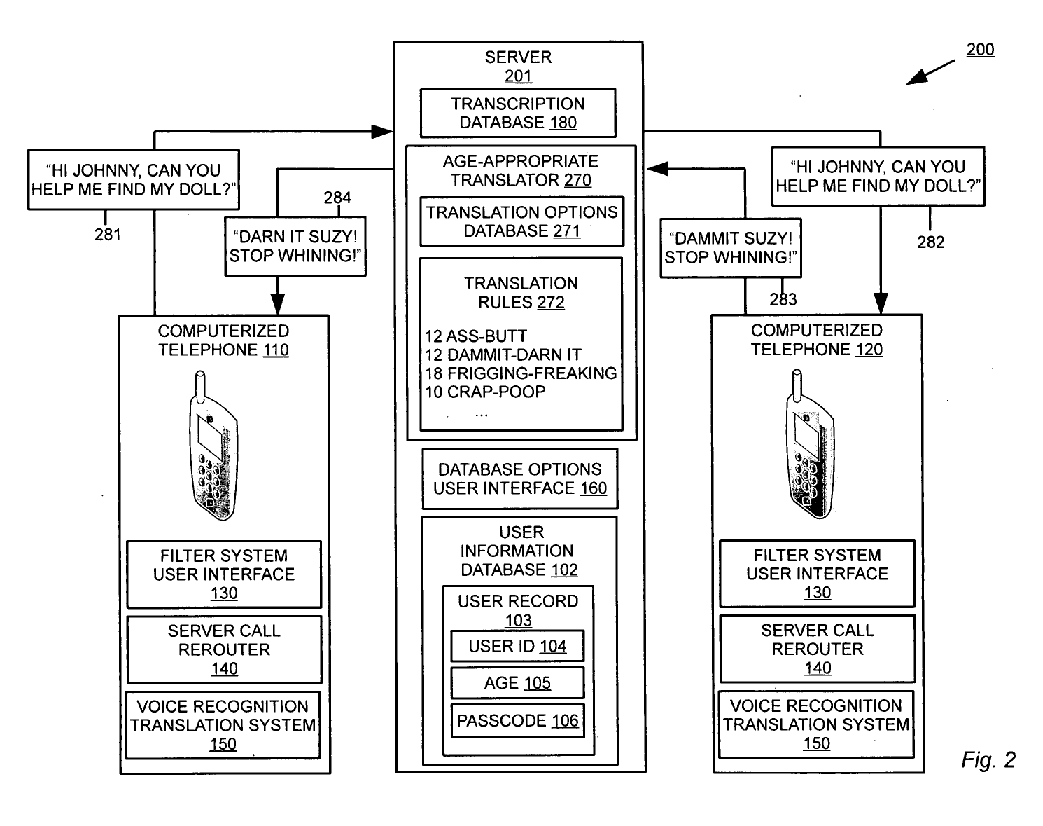

FIG. 2 is an operational block diagram of a server-based system 200 for language filtering in communication devices, in accordance with the present disclosure. System 200 generally illustrates language filtering in a conversation between a first participant using computerized telephone 110 and a second participant using computerized telephone 120. Computerized telephone 110 and computerized telephone 120 may be arranged to establish a communication link for communication across a network (such as cellular network 180, shown in FIG. 1).

When establishing the communication link, computerized telephone 110 and computerized telephone 120 may be authenticated by a network service provider. The network service provider may perform authentication across the network using, for example, a unique number assigned to the computerized telephones 110 and 120. The first and second participants may also be authenticated (for example, using voice signatures and/or comparing a user ID-passcode provided by each of the participants). In lieu of authenticating a particular user, a default user ID may be associated with a particular computerized telephone. Authentication may be formed at a computerized telephone level, a cellular and/or network level, and/or a server level.

After a communication link is established, the first user (who may be eight-years old as in the illustrated example) of computerized telephone 110 may speak into the phone to carry on a conversation with a second user (who may be 17-years old as in the illustrated example). Voice recognition translation system 150 may be arranged to translate spoken words into an encoded message (using encoding such as text and/or waveform). The encoded message may be routed by server call re-router 140 to server 201 as a communication 281 that may be sent to server 201 for potential filtering.

Server 201 may be arranged to receive communication 281 and may store the communication 281 using a transcription database 180. Communication 281 may be stored using session and/or communication link information of the phone call as indexes for accessing transcription database 180, for example. Server 210 may also be arranged to access user information database 102 to locate the user record 103 of the second user (who is the intended listener for communication 281). The user record 103 of the second user may also be accessed in order to determine information for locating user-appropriate translation rules.

In the illustrated example, the age of the second user may be determined to be 17-years old (by querying the user record 103 of the second user). Server 201 may be arranged to query translation options database 271 to determine whether any translation substitutions exist for communication 281 with respect to the second user. Age-appropriate translator 270 may be arranged to query translation rules 272 to compare the age of the second user with various ages stored in translation rules 272. In the illustrated example, age-appropriate translator 270 may be arranged to determine that no substitutions exist for the spoken words in the translation rules 272 for a 17-year-old level.

Accordingly, an unfiltered message may be sent through server 201 to the second user. In many embodiments, server 201 may be arranged to send some or all of communication 281 to computerized telephone 120 as communication 282, which may be then heard by the second user via computerized telephone 120. In many embodiments, server 201 may be arranged to instruct computerized telephone 110 to send some or all of communication 281 across a cellular network 180 to computerized telephone 120.

After the second user hears communication 282, the second user (who may be 17-years old as in the illustrated example) of computerized telephone 120 may speak into the phone to reply to the first user (who may be eight-years old as in the illustrated example). The second user may reply by using language that a parent of the first user may find inappropriate. Voice recognition translation system 150 may be arranged to translate spoken words into an encoded message (e.g., text and/or waveform). The encoded message may be routed by server call re-router 140 to server 201 as communication 283.

Server 201 may be arranged to receive communication 283 and may be further arranged to store the communication 283 using transcription database 180. Server 210 may also be arranged to access user information database 102 to locate the user record 103 of the first user. The user record 103 of the first user may be accessed in order to determine whether translation should be performed.

In the illustrated example, the age of the first user may be determined to be eight-years old from the respective user record 103. Server 201 may be arranged to query translation options database 271 to determine whether any translation substitutions exist for communication 281 with respect to the first user. Age-appropriate translator 270 may be arranged to query substitution table 272 using the age of the first user and content of communication 283, and in the example, determines that a substitution should made.

In the illustrated example, the ages stored in translation rules 272 may be higher than the age of the first user. Thus, any word listed in translation rules 272 may have a value for replacing, modifying, “bleeping” with a sound effect, or deleting (by silence) the listed word.

Accordingly, a filtered message may be sent to the first user via server 201 as communication 284. Communication 284 has at least some identified offensive content replaced such as, for example, with the words “dam it” The filtered message may be generated (e.g., via server 201) using the original encoded message and sound synthesis techniques. For example, voice recognition translation system 150 voice synthesis (including a using a voice model of the user) and/or recordings made by the user or other person can be arranged to fill in “gaps” left by filtered offensive content.

FIG. 3 is a functional block diagram of a server-based system 300 for language filtering in communication devices, in accordance with the present disclosure. As described above, system 300 may also be arranged to allow deleting, replacing, and/or modifying of offensive language based upon system settings and controls.

System 300 may include one or more of a server 301, a telephone 310, and/or a telephone 320. Server 301 and any of numerous telephones (such as telephones 310 and 320) may be coupled together using any suitable network (such as cellular network 180). Server 301 may comprise a user information database 102 for storing information about users using one or more user records 103. Database options user interface 160 may be arranged to include multilingual support for filtering offensive language from different languages.

Server 301 may also include age-appropriate translator 170 for age-appropriate translation of offensive language (including from different languages) in a conversation in accordance with the age of each participant in the conversation. The age-appropriate translation may be arranged to translate offensive language in a conversation in accordance with the age of each participant in the conversation using predetermined translation rules.

Server 301 may also include a transcription database 180 that may be arranged for storing and retrieving conversations (for example) between telephone 310 and the telephone 320. For example, transcription database 180 may be arranged to store the conversations (for example) during the course of filtering the conversations between (and/or among) the participants of the conversation.

Server 301 may also include voice recognition translation system 350 arranged to translate individual portions (such as words, phrases, and/or sounds) of a conversation if language in the conversation is identified as offensive. Voice recognition translation system 350 may also be arranged as a user interface to set options for language filtering by translating commands spoken by a user. Voice recognition translation system 350 may be arranged to filter offensive language from a conversation. Voice recognition software 350 may also be arranged to trigger a sound effect when deleting identified offensive content. The triggered sound effect may be dubbed over the synthesized speech such that the sound effect notifies the listener that a substitution has been made by voice synthesis.

Telephone 310 and telephone 320 each may comprise filter system user interface 130, and server call re-router 140. System user interface 130 may include (for example) a screen and/or keyboard for providing information and receiving user commands to select, activate, and/or individualize language filter options. Server call re-router 140 may be arranged to re-direct all or portions of language in a communication session between two users to server 301 to determine whether to filter the portions of language. For example, a listener can select a “bleep” button 321 that may re-direct incoming communications from telephone 310 to server 301 for filtering before being relayed back to telephone 320.

FIG. 4 is a functional block diagram of a peer-to-peer based system 400 for language filtering in communication devices, in accordance with the present disclosure. As described above, system 400 may also be arranged to allow deleting, replacing, and/or modifying of offensive language based upon system settings and controls.

System 400 may include telephone 410 and telephone 420, each arranged to communicate using network 480. In the illustrated embodiment, telephone 410 may be any telephone suitable for communications across a network (such as network 480). Telephone 420 may include a user information database 102 arranged for storing information about users using one or more user records 103.

Telephone 420 may also include age-appropriate translator 470, which may be arranged for age-appropriate translation of offensive language (including from different languages) in a conversation in accordance with the age of each participant in the conversation. The age-appropriate translation may be arranged to translate offensive language in a conversation in accordance with the age of each participant in the conversation using predetermined translation rules.

Telephone 420 may also include a transcription database 180, which may be arranged for storing and retrieving conversations (for example) between telephone 420 and other telephones (e.g., telephone 420). Transcription database 180 may be arranged to store the conversations (for example) during the course of filtering the conversations between (and/or among) the participants of the conversation.

Telephone 420 may also include voice recognition translation system 450, which may be arranged to translate individual portions (such as words, phrases, and/or sounds) of a conversation when language is identified in the conversation as offensive. Voice recognition translation system 450 may also be arranged as a user interface to set options for language filtering by translating commands spoken by a user. Voice recognition translation system 450 may be arranged to filter offensive language from a conversation. Voice recognition translation system 450 may employ a relatively slight delay (around 1 sec.-1.5 sec.) as the voice recognition software processes the data. Voice recognition software 450 may be arranged to trigger a sound effect when deleting identified offensive content.

Telephone 420 may further comprise a filter system user interface 430, which may include (for example) a screen and/or keyboard for providing information and receiving user commands to select, activate, and/or individualize language filter options. For example, a listener may be arranged to select a “bleep” button 421 that activates filtering for incoming communications from telephone 410.

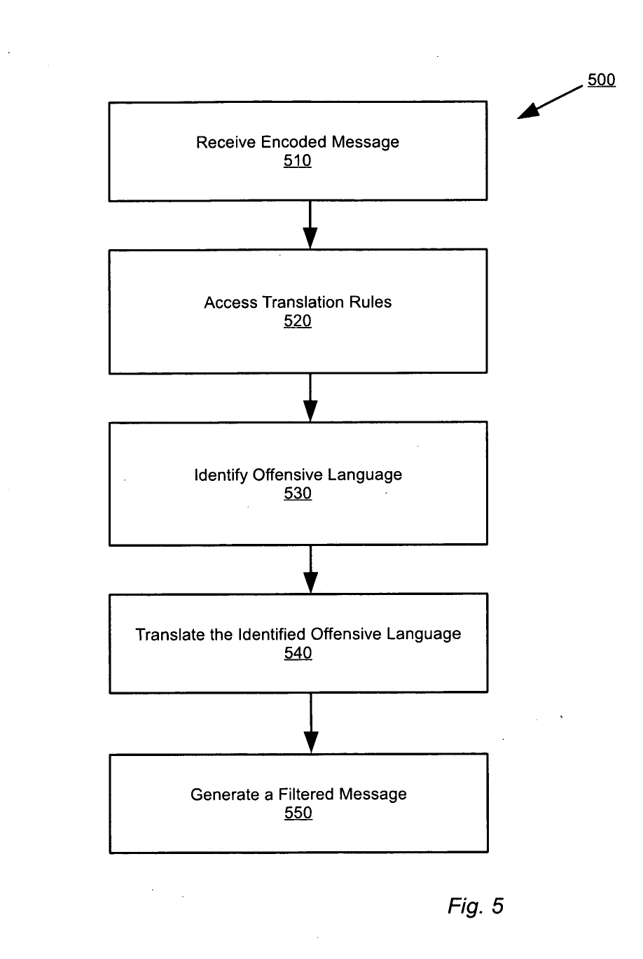

FIG. 5 is an operational flow diagram generally illustrating a process 500 for filtering offensive language, in accordance with the present disclosure. The process 500 includes one or more of operations 510, 520, 530, 540, and/or 550.

At operation 510, an encoded message may be received. The encoded message may be received by a computerized telephone that may be arranged with a translator and/or by a server that may be arranged with a translator. The encoded message may include a message spoken by a first user (who, for example, may be having a phone conversation with a second user). For example, the first user may speak into a telephone (such as a “plain old telephone,” cellular telephone, PDA, and the like) and the speech may be encoded into the encoded message. The encoded message may contain text, code, symbols, or any suitable electronic representation of the speech. Processing may continue from operation 510 to operation 520.

At operation 520, translation rules may be applied by the translator to identify offensive language in a portion of the encoded message. Offensive language may be identified by the translator by using the encoded message (or portions thereof) to access translation rules are associated with the second user. The translation rules may be accessed by parsing out individual words, phrases, and/or sounds in the encoded message. The parsed words, phrases, and/or sounds may be used as indexes to locate any translation rules that are associated with the parsing output. For example, the word “hell” may be used as an index that can be used to locate a rule that translates “hell” to “heck.” The rule may also be evaluated by the translator to determine whether an age limit is present. If an age limit is present, the age limit is compared with the age of the second user to determine whether to translate the word in the encoded message. Processing may continue from operation 520 to operation 530.

At operation 530, the offensive language in the encoded message may be identified by the translator that may be arranged to evaluate a rule that corresponds to the index produced by parsing the encoded message. The encoded message may be parsed piecewise repeatedly by the translator so that the entire encoded message may be reviewed to identify one or more portions of offensive language in the encoded message. Processing may continue from operation 530 to operation 540.

At operation 540, the identified offensive language in the encoded message may be translated. The identified offensive language in the encoded message may be translated by the translator of the computerized telephone or the server. The identified offensive language in the encoded message may be translated in accordance with the accessed translation rules. The translation rules may specify translation actions that may include (for example) one or more of deleting, replacing, modifying, and/or blocking portions (including the entire portion) of the identified offensive content within the encoded message. In many embodiments, the server may send the specified translation actions to the computerized telephone that may be arranged to translate the encoded message. Processing may continue from operation 540 to operation 550.

At operation 550, a filtered message may be generated by the translator of the computerized telephone and/or the server. For example, the translator may be arranged to synthesize voice waveforms. The translator may be arranged to utilize a voice model of the first user or may be arranged to utilize recorded waveforms associated with particular rules to translate the identified offensive language. The encoded message may thus be filtered by translating the identified offensive language to content specified by the rules that correspond to the identified offensive language

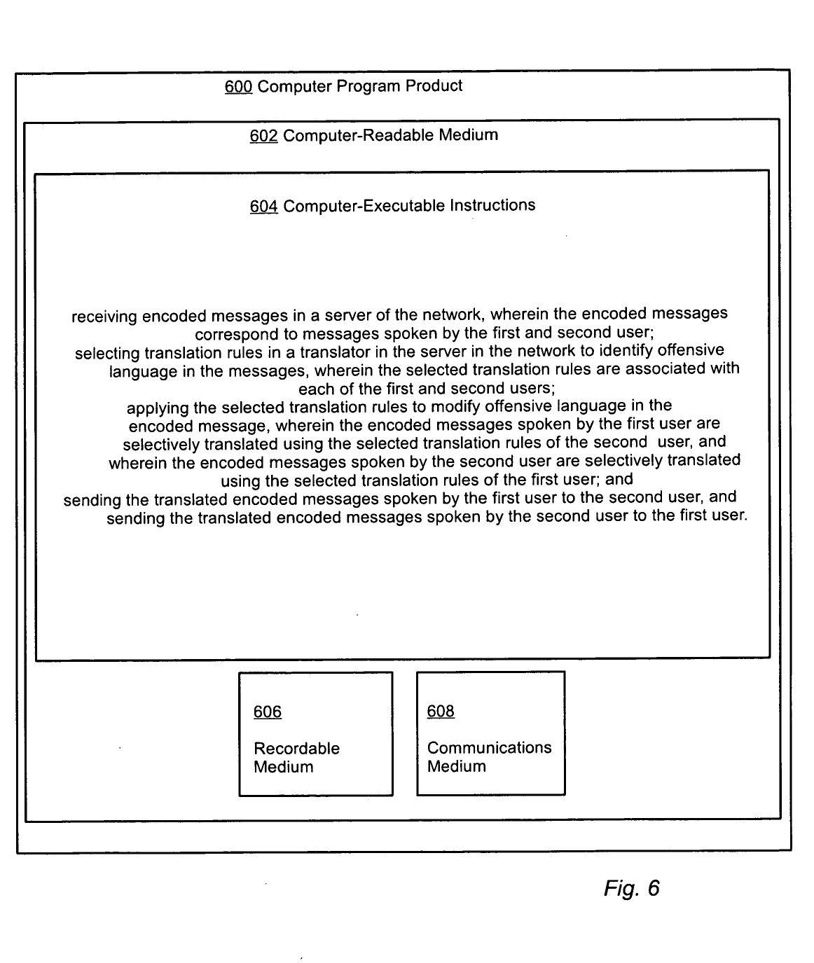

FIG. 6 is a diagram generally illustrating a computer product configured to provide language filtering as shown in FIG. 1, in accordance with the present disclosure. The computer program product 600 may take one of several forms, such as a computer-readable medium 602 having computer-executable instructions 604, a recordable medium 606, a communications medium 608, or the like. When the computer-executable instructions 604 are executed, a method is performed. The instructions 604 include, among others, receiving encoded messages, wherein the encoded messages are spoken by a first and second user in an electronic communication session between the first and second users; selecting translation rules to use for translating offensive language by using translation rules that are associated with respective devices of the first and second users; accessing the selected translation rules to identify offensive language in a portion of the encoded message, wherein the encoded messages spoken by the first user are selectively translated using the selected translation rules of the second user, and wherein the encoded messages spoken by the second user are selectively translated using the selected translation rules of the first user; and sending the translated encoded messages spoken by the first user to the second user, and sending the translated encoded messages spoken by the second user to the first user.

As will be appreciated by those persons skilled in the art, the system and method described herein affords distinct advantages not previously available to users of telephonic devices. The present system and method allows users to communicate with devices designed to selectively filter offensive communications in accordance with a user's intentions. For example, offensive content in communications can be filtered out, even without knowing beforehand whether the communications contain offensive content.

Example methods may be designed to filter (such as by deleting, blocking, replacing, and/or modifying) various offensive words, phrases, and/or sounds that have been identified as having offensive meanings. Thus, parents or guardians can shield their children in an age-appropriate manner. Standards (such as “PG-13”) may be used to simplify the process of specifying which kind of offensive language to filter by taking the age of the child into consideration.

In another aspect of the present disclosure, the architecture of the present system and method for language filtering may be scaled and distributed in accordance with system requirements. For example, the present system and method for language filtering may be embodied within one phone (such as may be used by a child) that may communicate with other phone in a peer-to-peer fashion over a cellular network. In another example, the present system and method for language filtering may be distributed in a client-server architecture, having client phones that access the server to access translation rules. The scalability and distribution of components of the present system and method for language filtering permits optimization of storage, power consumption and latency requirements.

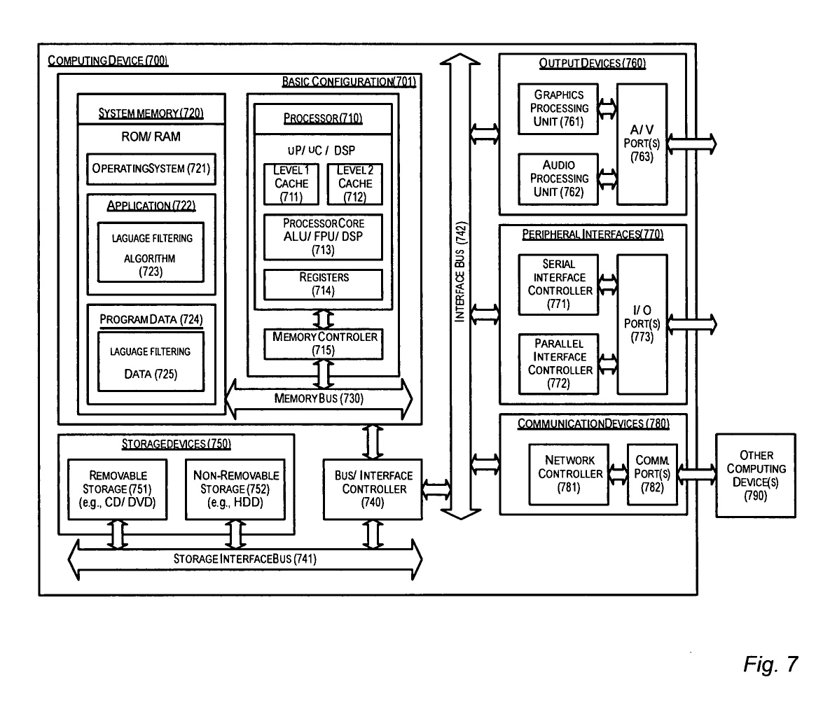

FIG. 7 is a block diagram illustrating an example computing device 700 that is arranged for language filtering, in accordance with the present disclosure. In a very basic configuration 701, computing device 700 typically includes one or more processors 710 and system memory 720. A memory bus 730 can be used for communicating between the processor 710 and the system memory 720.

Depending on the desired configuration, processor 710 can be of any type including but not limited to a microprocessor (gP), a microcontroller (gC), a digital signal processor (DSP), or any combination thereof. Processor 710 can include one more levels of caching, such as a level one cache 711 and a level two cache 712, a processor core 713, and registers 714. The processor core 713 can include an arithmetic logic unit (ALU), a floating point unit (FPU), a digital signal processing core (DSP Core), or any combination thereof. A memory controller 715 can also be used with the processor 710, or in some implementations the memory controller 715 can be an internal part of the processor 710.

Depending on the desired configuration, the system memory 720 can be of any type including but not limited to volatile memory (such as RAM), non-volatile memory (such as ROM, flash memory, etc.) or any combination thereof. System memory 720 typically includes an operating system 721, one or more applications 722, and program data 724. Application 722 may include language filtering algorithm 723, which may be arranged to control a language filtering system. Program Data 724 may include language filtering data 725 that may be useful for operating language filtering as has been further described above. In some embodiments, application 722 can be arranged to operate with program data 724 on an operating system 721 such that operation of a language filtering system may be facilitated on general purpose computers. This described basic configuration is illustrated in FIG. 7 by those components within line 701.

Computing device 700 can have additional features or functionality, and additional interfaces to facilitate communications between the basic configuration 701 and any required devices and interfaces. For example, a bus/interface controller 740 can be used to facilitate communications between the basic configuration 701 and one or more data storage devices 750 via a storage interface bus 741. The data storage devices 750 can be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 720, removable storage 751 and non-removable storage 752 are all examples of computer storage media. Computer storage media (or computer-readable medium) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of device 700.

Computing device 700 can also include an interface bus 742 for facilitating communication from various interface devices (e.g., output interfaces, peripheral interfaces, and communication interfaces) to the basic configuration 701 via the bus/interface controller 740. Example output devices 760 include a graphics processing unit 761 and an audio processing unit 762, which can be configured to communicate to various external devices such as a display or speakers via one or more A/V ports 763. Example peripheral interfaces 770 include a serial interface controller 771 or a parallel interface controller 772, which can be configured to communicate with external devices such as input devices (e.g., keyboard, mouse, pen, voice input device, touch input device, etc.) or other peripheral devices (e.g., printer, scanner, etc.) via one or more I/O ports 773. An example communication device 780 includes a network controller 781, which can be arranged to facilitate communications with one or more other computing devices 790 over a network communication via one or more communication ports 782. The communication link is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 700 can be implemented as a portion of a small-form factor portable (or mobile) computer such as a cell phone, a personal data assistant (PDA), a personal media player device, a wireless web-watch device, a personal headset device, an application specific device, or a hybrid device that include any of the above functions. Computing device 700 can also be implemented as a personal computer including both laptop computer and non-laptop computer configurations.

Additional advantages and modifications will readily occur to those skilled in the art. Therefore, the presently disclosure is to be construed broadly and is not limited to the specific details and representative embodiments shown and described herein. Accordingly, various modifications may be made without departing from the spirit or scope of the general inventive concept as defined by the appended claims and their equivalents.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various embodiments have been disclosed herein, other aspects and embodiments will be apparent to those skilled in art. The various sports and embodiments disclosed herein are for purposes of illustration and are not intended to be limiting, with the true scope and spirit being indicated by the following claims.

What is claimed is:

1. A method for a computer to filter offensive language from a communication over a network between a first user and a second user, the method comprising:
receiving an encoded message in the computer, wherein the encoded message corresponds to a message spoken from the first user;
applying translation rules in a translator of the computer to identify offensive language in the encoded message, wherein the translation rules are associated with the second user; and
translating in the translator of the computer the identified offensive language in accordance with the translation rules to generate a filtered message for sending to the second user.

2. The method recited in claim 1, further comprising identifying a personal criteria of the second user, and selecting the translation rules based at least on the identified personal criteria of the second user.

3. The method recited in claim 2, wherein the personal criterion comprises an age of the second user.

4. The method recited in claim 2, wherein the personal criterion comprises at least one of an age, a lifestyle choice, a religion, a sexual orientation, an ethical position, and/or a moral position.

5. The method recited in claim 1, further comprising comparing an age of the second user with specified age limits to select the translation rules to use in translating the identified offensive language.

6. The method recited in claim 1 further comprising comparing an age of the second user to age limits for each of the translation rules to select translation rules to use in translating the identified offensive language, wherein the age limits for each of the translation rules contains an age-appropriate value.

7. The method recited in claim 1, further comprising comparing an age of the second user to standard rules, wherein the standard rules comprise an age limit for each entry in the translation rules.

8. The method recited in claim 1, wherein translating the identified offensive language in accordance with the translation rules to generate the filtered message comprises replacing the identified offensive language with a replacement word stored in the translation rules.

9. The method recited in claim 1, wherein translating the identified offensive language in accordance with the translation rules to generate the filtered message comprises modifying the identified offensive language by substituting the identified offensive language with a modified word having a less offensive meaning than the identified offensive language.

10. The method recited in claim 1, wherein translating the identified offensive language in accordance with the translation rules to generate the filtered message comprises replacing the identified offensive language with a sound effect.

11. The method recited in claim 1, wherein translating the identified offensive language in accordance with the translation rules to generate a filtered message comprises replacing the identified offensive language with silence.

12. The method recited in claim 1, wherein the generating the filtered messages comprises modifying the encoded message.

13. The method recited in claim 1, further comprising using a voice model of the first user to generate the filtered message.

14. The method recited in claim 1, further comprising determining a particular meaning of a word in the encoded message by evaluating a context of the word in the encoded message.

15. The method recited in claim 1, further comprising using voice recognition of speech spoken by the second user to determine a user identifier associated with the second user.

16. The method recited in claim 1, further comprising using voice recognition on speech spoken by the second user in a conversation between the first and second user, wherein the voice recognition is arranged to determine that the second user has changed to a different user.

17. The method recited in claim 16, further comprising accessing translation rules to identify offensive language in the encoded message, wherein the translation rules are associated with the different user.

18. The method recited in claim 1, further comprising specifying the translation rules, wherein a parent or guardian or user edits the translation rules.

19. The method recited in claim 18, wherein the parent or guardian or user edits the translation rules using communications over the network.

20. The method recited in claim 18, further comprising using the device network or other network to access the translation rules in accordance with rules having words from different languages.

21. A computer device-readable medium encoded with computer-executable instructions for translating offensive language from a communication over a network between a first user and a second user, the computer-executable instructions comprising:
receiving encoded messages in a server of the network, wherein the encoded messages correspond to messages spoken by the first and second user;
selecting translation rules in a translator in the server in the network to identify offensive language in the messages, wherein the selected translation rules are associated with each of the first and second users;
applying the selected translation rules to modify offensive language in the encoded message, wherein the encoded messages spoken by the first user are selectively translated using the selected translation rules of the second user, and wherein the encoded messages spoken by the second user are selectively translated using the selected translation rules of the first user; and
sending the translated encoded messages spoken by the first user to the second user, and sending the translated encoded messages spoken by the second user to the first user.

22. A system for filtering offensive language from a communication over a network between a first user and a second user, the system comprising:
a computer-readable storage medium arranged to store computer-readable instructions;
a voice recognition translator that is configured by the computer-readable instructions from the computer-readable storage medium to receive an encoded message, wherein the encoded message corresponds to a message spoken by the first user; and
a translator that is configured to apply translation rules to identify offensive language in the encoded message, wherein the translation rules are associated with the second user, and wherein the translator is further configured to translate the identified offensive language based at least in part on the translation rules and a personal criterion of the second user to generate a filtered message for sending to the second user.

23. The system recited in claim 22, wherein the second user operates a device comprising the computer-readable storage medium, the voice recognition translator, and the translator.

24. The system recited in claim 22, wherein a server comprises the translator, wherein the server is coupled to the network, wherein the first user operates a first device that is coupled to the network, and the second user operates a second device comprising the computer-readable storage medium and the voice recognition translator.

25. The system recited in claim 22, wherein the personal criterion comprises at least one of an age, a lifestyle choice, a religion, a sexual orientation, an ethical position, and/or a moral position.
